(19) United States
(12) Patent Application Publication
(10) Pub. No.: US 2008/0269961 A1
(43) Pub. Date: Oct. 30, 2008

(54) VEHICULAR AUDIO/VISUAL DEVICE, VEHICULAR AUDIO/VISUAL SYSTEM, DEVICE IDENTIFICATION METHOD, PROGRAM, AND COMPUTER-READABLE STORAGE MEDIUM

(75) Inventors: Kazuhisa SHITANAKA, Toyota-shi (JP); Terumi KUWANO, Handa-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: TOYOTA JIDOSHA KABUSHIKI KAISHA, Toyota-shi (JP)

(21) Appl. No.: 12/106,656

(22) Filed: Apr. 21, 2008

(30) Foreign Application Priority Data
Apr. 27, 2007 (JP) 2007-118849

(51) Int. Cl. G06F 17/00

(52) U.S. Cl. 701/2

(57) ABSTRACT

A vehicular AV device includes a communication unit preferentially wirelessly communicating with a portable media output device identified according to initially recorded device identification information; a registration unit storing in a user information storage unit user identification information of a user acquired from a user identification unit identifying the user riding in a vehicle and the device identification information acquired by the communication unit in association with each other; a device identification unit reading from the user information storage unit the device identification information associated with the user identification information of the user riding in the vehicle when the user rides in the vehicle; and an identification information notification unit notifying the communication unit of the device identification information. The communication unit communicates with the portable media output device of the notified device identification information even if the notified device identification information is not initially recorded.

### BACKGROUND OF THE INVENTION

1. Field of the Invention

The present invention relates generally to vehicular audio/visual devices that output audio/visual data and, in particular, to a vehicular audio/visual device and a vehicular audio/visual system that output audio/visual data received from a portable media output device, and it also relates to a device identification method of the vehicular audio/visual device, a program, and a computer-readable storage medium.

2. Description of the Related Art

In some cases, plural users share a single vehicle for driving, but they have their own preferences (hereinafter simply referred to as vehicle settings) in driving positions, temperature settings, etc. Therefore, the driver riding in a vehicle is required to change the vehicle settings to suit his/her preferences. In order to deal with this cumbersome operation, techniques of automatically performing the vehicle settings have been proposed (see, e.g., Patent Document 1). Patent Document 1 discloses a technique of automatically performing the vehicle settings for each driver, in which the driver is identified using the ID code of the electronic key detected when the driver is certificated according to a keyless entry system and setting information stored in association with the ID code is read.

Furthermore, in order to deal with the diversified preferences of listeners in an audio system, particularly, a technique has been proposed in which preferred sound quality is set in advance for each driver so that he/she can change the settings of sound quality just by inputting the self-identification code (see, e.g., Patent Document 2).

Patent Document 1: JP-A-2003-127831

Patent Document 2: JP-A-2006-96210

### SUMMARY OF THE INVENTION

Meanwhile, users sharing a single vehicle often carry their own portable music players, and an audio system has been realized in which an in-vehicle device is wired or wirelessly connected to the portable music player to reproduce music of the portable music player even in a vehicle and output the same from a speaker of the vehicle. However, a connecting operation is required for each portable music player to establish a wired or wireless connection between the in-vehicle device and the portable music player. Therefore, the driver is disadvantageously required to perform the connecting operation for his/her portable music player every time he/she rides in the vehicle.

In view of the above problem, the present invention may provide a vehicular audio/visual device and a vehicular audio/visual system that reduce a connecting operation for a portable device. In addition, it may provide a device identification method of the vehicular audio/visual device, a program, and a computer-readable storage medium.

Accordingly, a vehicular audio/visual device is provided that comprises: a communication unit (e.g., BT module 30) that preferentially wirelessly communicates with a portable media output device identified according to initially recorded device identification information (e.g., equipment ID); a registration unit 25a that stores in a user information storage unit (e.g., storage unit 26 and user information 26a) user identification information (e.g., ID code) of a user acquired from a user identification unit (e.g., matching ECU 22) that identifies the user riding in a vehicle and the device identification information acquired by the communication unit in association with each other; a device identification unit (e.g., identification unit 25b) that reads from the user information storage unit the device identification information associated with the user identification information of the user riding in the vehicle acquired by the user identification unit when the user rides in the vehicle; and an identification information notification unit 25c that notifies the communication unit of the device identification information read by the device identification unit. The communication unit communicates with the portable media output device of the notified device identification information even if the notified device identification information is not initially recorded.

According to this configuration, the device identification information of the portable media output device can be stored in association with the user identification information of the user riding in the vehicle, and the device identification information is read and reported based on the user identification information when the user rides in the vehicle next time. Therefore, the portable media output device and the vehicular audio visual device are connected to each other without performing the connecting operation again, thereby making it possible to output audio/visual data from a device installed in the vehicle.

According to the embodiment of the present invention, it is possible to provide a vehicular audio/visual device and a vehicular audio/visual system that reduce a connecting operation for a portable device. In addition, it is possible to provide a device identification method of the vehicular audio/visual device, a program, and a computer-readable storage medium.

Other objects and further features of the present invention will be apparent from the following detailed description when read in conjunction with the accompanying drawings.

### BRIEF DESCRIPTION OF THE DRAWINGS

FIG. 1 is an example of a schematic configuration diagram of a vehicular audio/visual system;

FIG. 2 is an example of a block diagram of the vehicular audio/visual system;

FIG. 3 is an example of a block diagram of a portable music player;

FIG. 4 is a flowchart for showing a registration procedure in which the vehicular audio/visual device registers user information;

FIG. 5 shows an example of the user information; and

FIG. 6 shows a flowchart for showing a procedure in which the vehicular audio/visual device identifies the portable music player using the user information.

### DESCRIPTION OF THE PREFERRED EMBODIMENTS

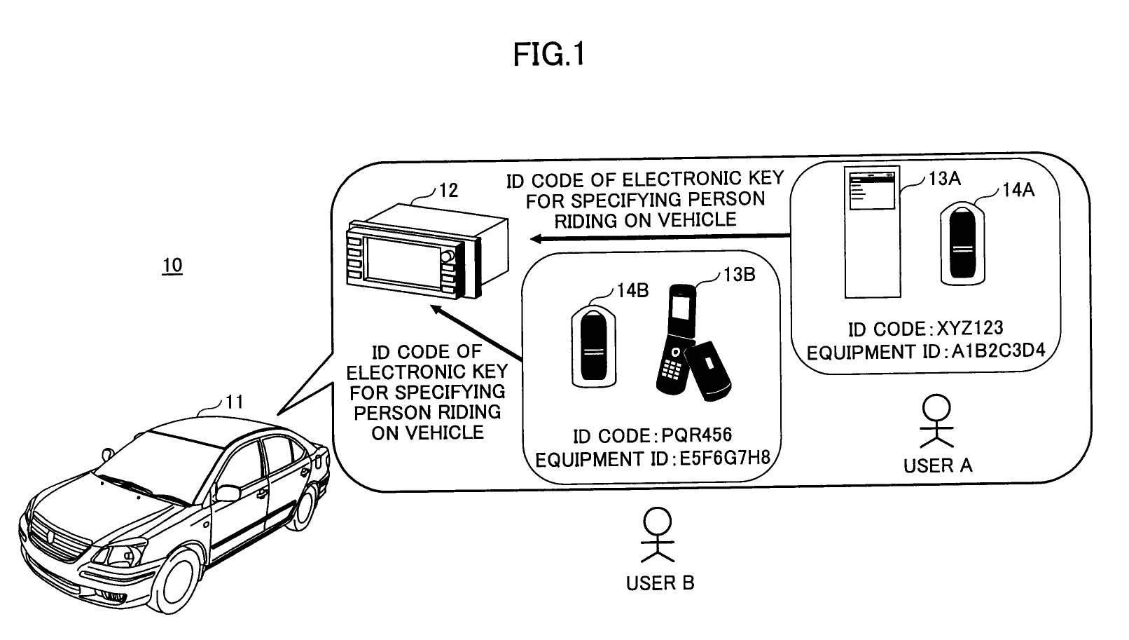

Referring to the accompanying drawings, a description is made of the best mode for carrying out an embodiment of the present invention. FIG. 1 is a diagram showing a schematic configuration of a vehicular audio/visual system (hereinafter simply referred to as a vehicular AV system) 10.

In a vehicle 11, a vehicular audio/visual device (hereinafter simply referred to as a vehicular AV device) 12 is mounted. User A who drives the vehicle 11 carries a portable music player 13A and an electronic key 14A; user B carries a portable music player 13B and an electronic key 14B (hereinafter, in some cases, the portable music players 13A and 13B are simply referred to as a portable music player 13, the electronic keys 14A and 14B are simply referred to as an electronic key 14, and users A and B are simply referred to as the user). The electronic keys 14A and 14B are inherent in users A and B, respectively.

According to the vehicular AV system 10 of the embodiment, users A and B are each identified according to the key ID stored in the electronic key 14, and the equipment ID of the portable music player 13 is previously registered in the vehicular AV device 12 in association with the key ID. After the registration, the associated equipment ID is extracted when the key ID is acquired by a keyless entry system (hereinafter referred to as KLES), so that the vehicular AV device 12 can extract connecting information inherent in the portable music player 13. Accordingly, users A and B are allowed to connect the portable music player 13 and the vehicular AV device 12 to each other without performing a connecting operation and output the audio reproduced by the portable music player 13 from a speaker.

Note that in FIG. 1 the equipment IDs of the portable music players 13A and 13B are A1B2C3D4 and E5F6G7H8, respectively, and the ID codes of the electronic keys 14A and 14B are XYZ123 and PQR456, respectively.

The portable music player 13 may be of any form so long as it has an audio output function for compressed audio source data such as MP3, CDs, DVDs, And one-segment broadcasting; it does not matter what types of names such as MP3 player, portable telephone, PDA, and PHS are given.

Furthermore, the portable music player 13 and the vehicular AV device 12 have their own communication devices (BT modules 45 and 30, respectively) for mutually performing wireless communications, thereby making it possible to wirelessly transmit the reproduced audio and video data of the portable music player 13 to the vehicular AV device 12. Examples of the wireless communications include Bluetooth (registered trademark: hereinafter referred to as BT), wireless LAN, infrared communication, etc., but BT is used for communications in the embodiment.

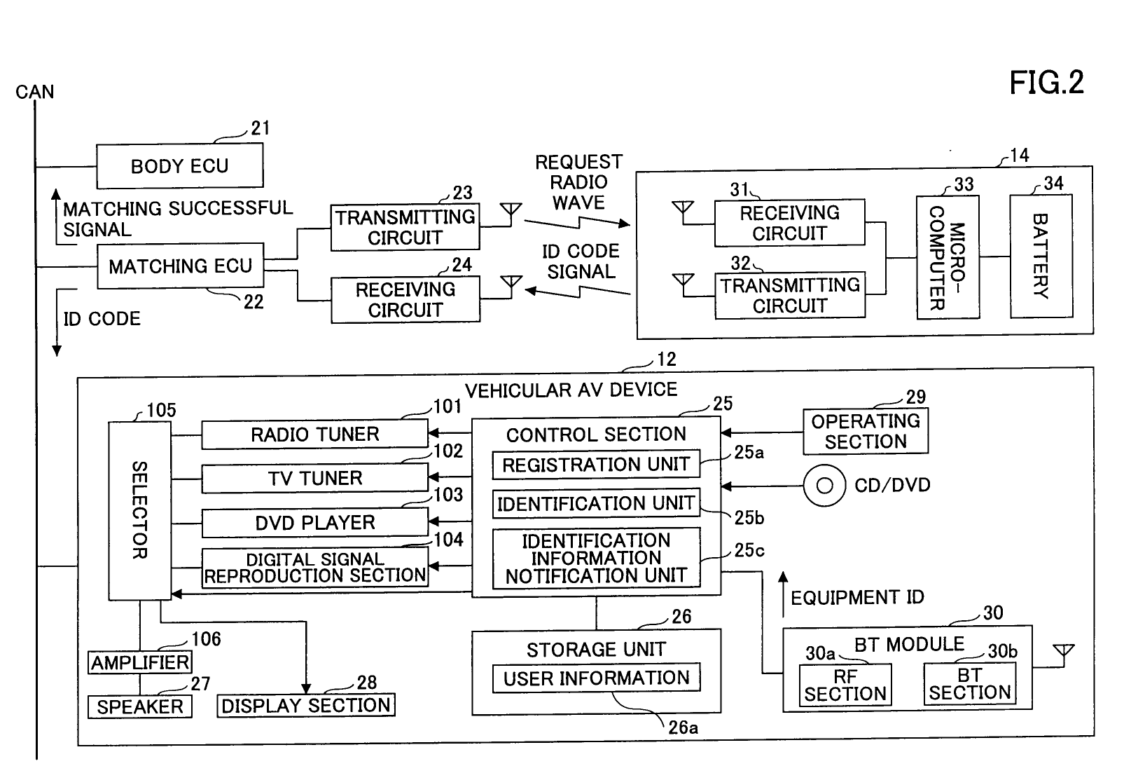

FIG. 2 shows a block diagram of the vehicular AV system 10. Here, KLES is briefly described. In KLES, a door is automatically unlocked when the user carrying the electronic key 14 approaches the door of the vehicle 11 and is automatically locked when he/she leaves the vehicle 11. In addition, KLES has an ignition function so that the user can start an engine with a mechanical key by rotating an ignition knob without turning an ignition switch on.

A transmitting circuit 23 mounted in the vehicle modulates a carrier with the request signal output from a matching ECU 22 to transmit a request radio wave via an antenna. The transmitting circuit 23 transmits the request radio wave for each recycling time to thereby form the detection area of the electronic key 14. A receiving circuit 24 demodulates the ID code signal transmitted from the electronic key 14 to output its ID code to the matching ECU 22.

The electronic key 14 has a battery 34, a microcomputer 33, a receiving circuit 31, and a transmitting circuit 32. The receiving circuit 31 demodulates the request radio wave transmitted from the vehicle 11 received via the antenna to output a request signal to the microcomputer 33. In response to the input of the request signal, the microcomputer 33 outputs the previously stored ID code of the electronic key 14 to the transmitting circuit 32. The transmitting circuit 32 modulates a carrier with the ID code to transmit the ID code signal via an antenna.

The matching ECU 22 is a computer having a CPU, a memory, etc., and the ID code of the electronic key 14 is previously stored in the memory. The matching ECU 22 matches the ID code acquired from the receiving circuit 24 with the stored ID code, and it transmits a matching successful signal to a body ECU 21 if they are matched with each other. Upon receipt of the matching successful signal, the body ECU 21 unlocks the door.

Furthermore, if the ID code and the stored ID code are matched with each other, the matching ECU 22 transmits the ID code received from the electronic key 14 to the vehicular AV device 12 in accordance with the request from the vehicular AV device 12. Accordingly, the vehicular AV device 12 is allowed to identify the user who approaches the vehicle 11.

The vehicular AV device 12 is disposed, for example, on a 2DIN-type front console in the vehicle with its display section 28 facing the passenger side. An operating section 29 of the vehicular AV device 12 is provided at the periphery of the display section 28 to constitute a user interface. The operating section 29 comprises various keys, a dial, pointer operating elements such as a track pointer and a mouse, and a microphone for audio operations. Furthermore, a remote controller may be used as the operating section 29.

The vehicular AV device 12 is controlled by a control section 25 configured to be a computer having a CPU, a RAM, a ROM, etc. When the operating section 29 is operated by the user, the control section 25 executes a process for controlling respective sections to effect corresponding operations. The CPU of the control section 25 executes programs to thereby realize a registration unit 25a that registers the ID code and the equipment ID in user information 26a, an identification unit 25b that identifies the portable music player 13 carried by the user based on the ID code, and an identification information notification unit 25c that notifies the BT module 30 of the equipment ID of the portable music player 13.

In a storage unit 26 connected to the control section 25, the user information 26a as described below is stored. The user information 26a is information in which the equipment ID of the portable music player 13 is registered in association with the ID code of the electronic key 14.

The vehicular AV device 12 is capable of outputting compressed audio source data of radio, TV, DVD, MP3, etc., as a media source, and it has a radio tuner 101, a TV tuner 102, a DVD player 103, and a digital signal reproduction section 104 correspondingly. On the display section 28, video images of TV broadcasting and DVD content are displayed in accordance with the operating conditions of the vehicular AV device 12. Furthermore, the display section 28 selectably displays these media sources in list form, and it may display the operating statuses of a TV station, a radio broadcasting station, etc., in accordance with a selected media source. Where the display section 28 serves also as the display section for a navigation system, it displays road maps.

The radio tuner 101 receives, for example, AM/FM analog/digital broadcasting of a dialed broadcasting station via a predetermined antenna. The radio tuner 101 outputs the audio signal obtained by demodulating the signal of the dialed broadcasting station to a selector 105. The TV tuner 102 receives, for example, analog/digital terrestrial broadcasting, so-called one-segment broadcasting of a dialed broadcasting station via a predetermined antenna. The TV tuner 102 adjusts receiving sensitivity in accordance with the radio field intensity from the broadcasting station and outputs video and audio signals separated based on the frequency to the selector 105.

The DVD player 103 reads a digital signal from a DVD inserted through a predetermined inserting port, decodes a video signal in MPEG2 format or the like and an audio signal in PCM format or the like to be converted into video and audio analog signals, respectively, and outputs them to the selector 105. The digital signal reproduction section 104 decodes compressed audio source data stored in the storage unit 26 or a transportable storage medium and outputs their audio signals to the selector 105.

Furthermore, the selector 105 and the control section 25 are connected to each other, and reproduction data (audio reproduction data and video reproduction data) received by the BT module 30 as described below can be directly output to the selector 105 via the control section 25.

Upon receipt of instructions for outputting the media source such as radio from the operating section 29, the control section 25 selects corresponding signals from among the audio and video signals input to the selector 105 and outputs the corresponding audio and video signals to an amplifier 106 and the display section 28, respectively. After amplifying the level of the input audio signal, the amplifier 106 outputs the amplified audio signal to the speaker 27. Furthermore, the display section 28 displays the input video signal.

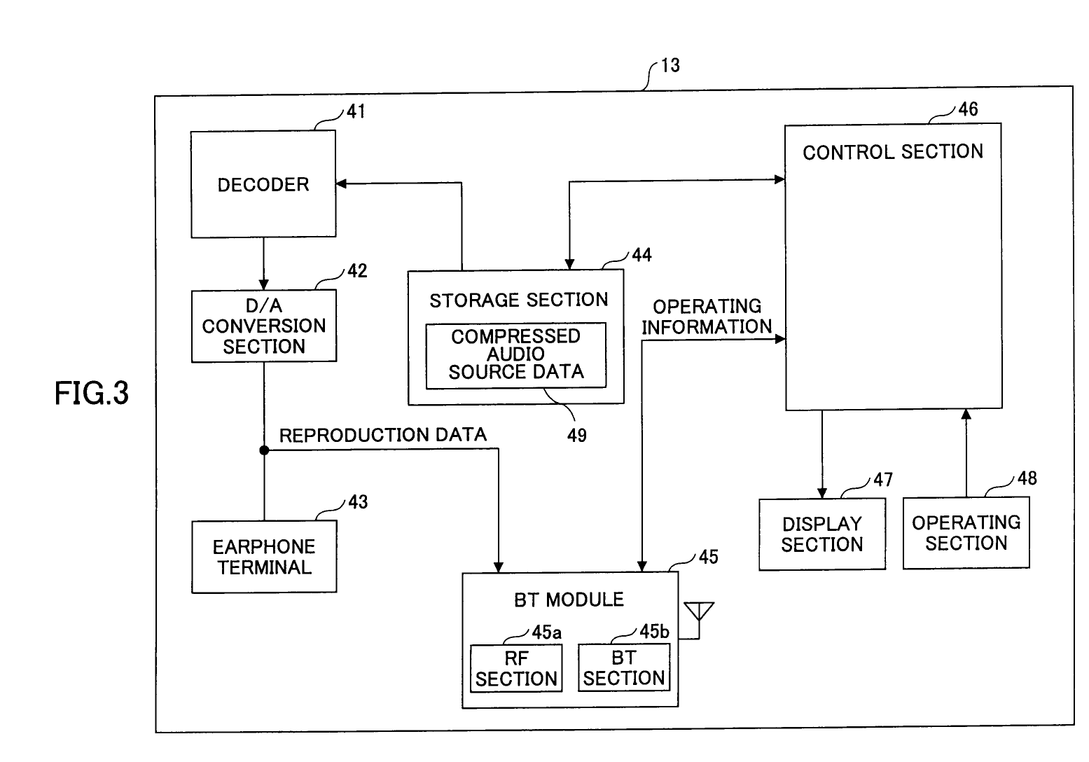

FIG. 3 shows a block diagram of the portable music player 13. The portable music player 13 is controlled by a control section 46 configured to be a computer having a CPU, a RAM, a ROM, etc. When an operating section 48 is operated by the user, the control section 46 executes a process for controlling various sections to effect corresponding operations.

In a storage section 44 composed of a flash memory or a hard disk, compressed audio source data 49 in MP3 format or the like are stored. The control section 46 requests a decoder 41 to read the compressed audio source data 49 from the storage section 44 in accordance with the operations of a passenger. Because the compressed audio source data 49 are compressed (subjected to codec) by a predetermined compression method, the decoder 41 expands (decodes) them in accordance with the compression method. The expanded digital data are input to a D/A conversion section 42, and the D/A conversion section 42 converts the digital data into reproduction data.

The reproduction data are output to an earphone terminal, but they are partially branched to also be supplied to the BT module 45. Accordingly, when the portable music player 13 is connected to the vehicular AV device 12 via the BT module 45, the reproduction data are capable of being output from the speaker 27 of the vehicular AV device 12.

Note that in the embodiment a description is made of a case where the audio reproduced by the portable music player 13 is output. But, even where the reproduction data of video images such as still images and moving images are output, they can be similarly displayed on the display section 28 via the BT module 45.

Here, the BT modules 30 and 45 are described. The BT modules 30 and 45 respectively have RF sections 30a and 45a that establish wireless communications as a physical layer and BT sections 30b and 45b that perform a process in accordance with the specifications of the BT. According to BT, synchronous connection oriented (SCO) connection and asynchronous connectionless link (ACL) connection are defined as connection methods of the RF sections 30a and 45a. SCO connection is a line connection type point-to-point link formed between the BT modules 30 and 45 and mainly used to transfer audio data. ACL connection is a link that establishes a packet-switching-type connection between the BT modules and mainly used to transfer data.

According to BT, the (call mode) side that calls a connectable BT module using a paging message is referred to as a master station and the (stand-by mode) side that is connected in response to the paging message is referred to as a slave station. In the embodiment, the BT modules 30 and 45 serve as the master station and the slave station, respectively. When the slave station responds to the paging message, a connection is established. A network formed between the master station and the slave station is called a piconet.

The BT sections 30b and 45b of the BT modules 30 and 45 each execute a process for establishing in-piconet synchronization with the other BT module, a process for encoding/decoding a transmission/reception signal, etc. In other words, the respective BT modules 30 and 45 apply digital modulation to carrier signals using transmission data when transmitted and then apply spread spectrum processing to the modulated carrier signals by frequency hopping that switches the frequency for each predetermined time. After amplifying the transmission signals to a transmission output level smaller than or equal to a specified value, the BT modules 30 and 45 transmit the amplified transmission signals to the BT modules 45 and 30, respectively, of the other communication party via the antennas. The BT modules 30 and 45 receive the wireless signals incoming from the other communication party via the antennas and apply inverse spread spectrum processing to them, followed by digital demodulation.

Here, the profile of BT is described. According to BT, the BT modules 30 and 45 as the master station and the slave station, respectively, have the same profile to thereby ensure their mutual connections. General access profile (GAP) provides basic conditions such as synchronization between a frequency and a clock for frequency hopping, link control using an ID, and control of a packet size, and decomposing and assembling of data. Service discovery application profile (SAD) is for assisting the BT modules 30 and 45 to find available services and provides a function and a procedure for searching for the services and obtaining required information.

Serial port profile (SPP) provides conditions where serial communications are emulated, and it enables wireless communications via a virtual serial port. Audio reproduction data are provided in advanced audio distribution profile (A2DP) as a lower profile of SPP. A2DP ensures a sufficient data capacity by ACL connection to realize the transfer of high-quality data without using SCO connection used to transfer audio data.

Furthermore, when the BT modules 30 and 45 are connected to each other, the portable music player 13 can be operated by operating the operating section 29. In order to realize this remote operation, audio/video remote control profile (AVRCP) is provided.

Where the portable music player 13 has a call function, the provision of hands free profile (HFP) enables a hands free call. HFP provides the input and output of the audio from the remote BT modules 30 and 45. Because of the characteristics of a telephone call, HFP provides the handling of an AT command, the transmission of a radio field intensity and a caller ID, the use of a redial function and a telephone book function, echo cancellation, etc. In hands free mode, the audio from the user is transmitted from the BT module 30 to the BT module 45 via the microphone installed in the vehicle and sent out from the portable music player 13 to a telephone network. Furthermore, the audio received by the portable music player 13 is transmitted from the BT module 45 to the BT module 30 and output from the speaker 27.

The BT modules 30 and 45 are each provided with an inherent equipment ID. In order to connect the BT modules 30 and 45 to each other, a communication party is identified according to the equipment ID. When the portable music player 13 in stand-by mode enters the piconet in call mode, the portable music player 13 automatically transmits the equipment ID to the vehicular AV device 12 and is connected. However, when the BT modules 30 and 45 are first connected to each other, the input of a PIN key (ID number) is required. A correct PIN key is input to thereby complete a pairing operation. Subsequently, the connection is established only if one of the BT modules 30 and 45 enters the piconet. In other words, in the embodiment, the pairing operation corresponds to a connecting operation and the PIN key corresponds to connecting information.

Where plural users share the vehicle 11, the PIN key inherent in the portable music player 13 of the last user (e.g., user A) who has ridden in the vehicle is the default PIN key in the BT module 30 of the vehicular AV device 12. Therefore, when the same user, user A, rides in the vehicle, the BT modules 30 and 45 are connected without the connecting operation. However, when user B rides in the vehicle, it is not until the connecting operation is performed again that the BT modules 30 and 45 can be connected to each other even if the connecting operation has previously been performed. Note that where the connecting operation has previously been performed, the connecting information and the equipment ID are stored in pairs in the BT modules 30 and 45 by a predetermined number as an upper limit.

According to the embodiment, the portable music player 13 is identified based on the ID code of the electronic key 14 and the control section 25 notifies the BT module 30 of the equipment ID of the portable music player 13, thereby notifying the BT module 30 of the connecting information to be used. Accordingly, the portable music player 13 that has previously performed the connecting operation is allowed to establish the connection with the vehicular AV device 12 without performing the connecting operation again.

(Registration of the ID Code of the Electronic Key 14 and the Equipment ID of the Portable Music Player 14)

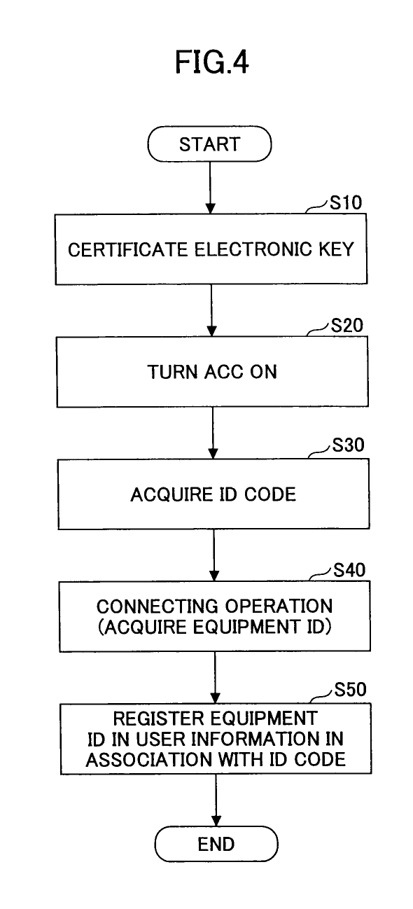

FIG. 4 is a flowchart for showing a registration procedure in which the vehicular AV device 12 registers the user information 26a. The user information 26a is updated when the vehicular AV device 12 is connected to a new portable music player 13, but the process in FIG. 4 starts from the certification of the electronic key 14 for illustrative purposes.

When the user carrying the electronic key 14 approaches the door of the vehicle 11, the electronic key 14 transmits the ID code signal to the vehicle 11 in response to the request signal. Then, the matching ECU 22 matches the transmitted ID code with the previously stored ID code. If they are matched with each other, the matching ECU 22 certifies the electronic key 14 (S10). Accordingly, the body ECU 21 unlocks the door.

When the user rides in the vehicle 11 and turns on an accessory power supply (ACC) (S20), power is supplied to the vehicular AV device 12 and the BT module 30. Then, the vehicular AV device 12 and the BT module 30 are activated.

Upon activation of the vehicular AV device 12, the registration unit 25a requests the matching ECU 22 to transmit the matching successful ID code and then acquires the ID code from the matching ECU 22 (S30). Because the ID code corresponds to the identification information of the user, the user riding in the vehicle can be identified according to the ID code. For example, when users A and B ride on the vehicle, the ID codes XYZ123 and PQR456 are acquired by the registration unit 25a, respectively.

Here, the user performs the connecting operation (pairing operation) to first connect the portable music player 13 to the vehicular AV device 12. When the connecting operation is completed, the BT module 30 acquires the equipment ID of the portable music player 13 (S40). Furthermore, the BT module 30 stores the equipment ID pairing with the PIN key in the connecting operation. For example, the BT module 30 acquires the equipment ID A1B2C3D4 when user A rides in the vehicle and the equipment ID E5F6G7H8 when user B rides in the vehicle. Accordingly, the BT modules 30 and 45 are connected, thereby making it possible to output the audio reproduction data from the speaker 27.

Next, the registration unit 25a requests the BT module 30 to transmit the equipment ID and then acquires the equipment ID from the BT module 30. It registers the equipment ID in the user information 26a in association with the ID code.

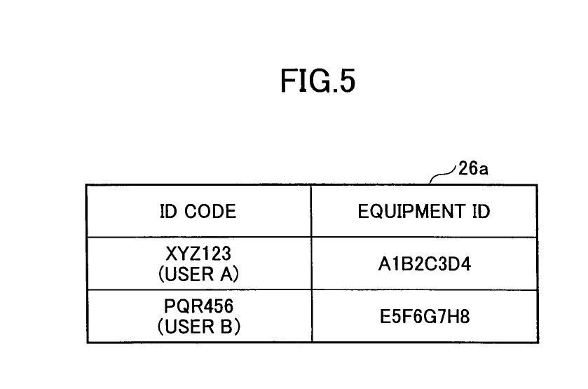

FIG. 5 shows an example of the user information 26a. The ID codes XYZ123 and PQR456 are stored in the user information 26a in association with the equipment IDs A1B2C3D4 and E5F6G7H8, respectively. Where the same user carries different portable music players 13, the ID code and the equipment ID are most recently registered in pairs. In this case, the equipment ID lastly registered is recognized as the portable music player 13 that the user carries.

(Identification of the Portable Music Player 13)

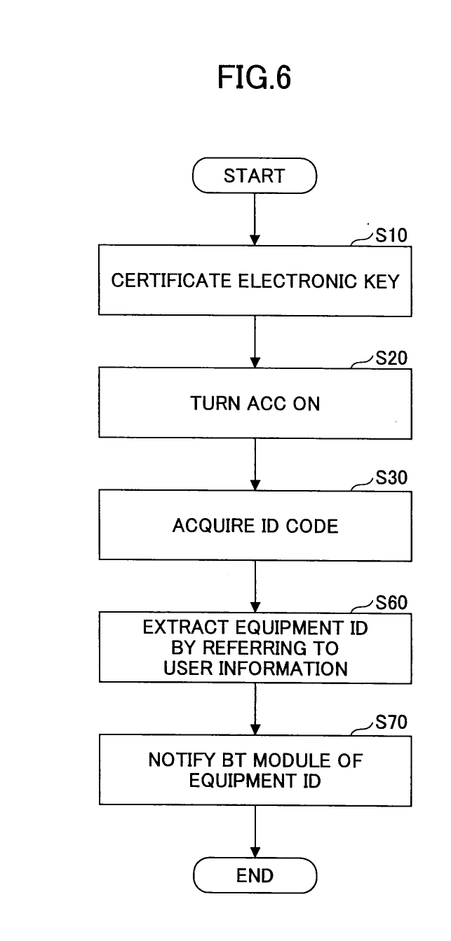

A description is made of the identification of the portable music player 13 using the user information 26a based on a flowchart of FIG. 6. The process based on the flowchart of FIG. 6 starts from the certification of the electronic key 14.

When the user carrying the electronic key 14 approaches the door of the vehicle 11, the electronic key 14 transmits the ID code signal to the vehicle 11 in response to the request signal. Then, the matching ECU 22 matches the transmitted ID code with the previously stored ID code. If they are matched with each other, the matching ECU 22 certifies the electronic key 14 (S10). Accordingly, the body ECU 21 unlocks the door.

When the user rides in the vehicle 11 and turns on the accessory power supply (ACC) (S20), power is supplied to the vehicular AV device 12 and the BT module 30. Then, the vehicular AV device 12 and the BT module 30 are activated.

Upon activation of the vehicular AV device 12, the identification unit 25b requests the matching ECU 22 to transmit the matched ID code and acquires the ID code from the matching ECU 22 (S30). For example, the identification unit 25b acquires the ID code XYZ123 when user A rides in the vehicle and the ID code PQR456 when user B rides in the vehicle.

Next, the identification unit 25b extracts the equipment ID associated with the acquired ID code by referring to the user information 26a (S60). Accordingly, the identification unit 25b is allowed to identify the portable music player 13 that the user carries. For example, the equipment IDs A1B2C3D4 and E5F6G7H8 are extracted when the acquired ID codes are XYZ123 and PQR456, respectively.

Then, the identification information notification unit 25c notifies the BT module 30 of the extracted equipment ID (S70). Upon notification of the equipment ID, the BT module 30 is put in call mode using the PIN key stored pairing with the equipment ID, and it is connected when the portable music player 13 enters the piconet. Accordingly, when the user operates the operating section 29, reproduction data are transmitted from the portable music player 13 to the vehicular AV device 12 so that they can be output from the speaker 27.

As described above, according to the vehicular AV system 10 of the embodiment, the vehicular AV device 12 wirelessly communicates with the portable music player 13 to reproduce an audio or the like using the speaker 27 installed in the vehicle without performing the connecting operation every time the user rides in the vehicle.

Note that the ID code of the electronic key 14 is used to identify the user in the embodiment, but biometric identification information such as the face, fingers, and fingerprints, weight, etc., may be used instead.

The present invention is not limited to these embodiments, but variations and modifications may be made without departing from the scope of the present invention.

The present application is based on Japanese Priority Application No. 2007-118849 filed on Apr. 27, 2007, with the Japanese Patent Office, the entire contents of which are hereby incorporated by reference.

What is claimed is:

1. A vehicular audio/visual device comprising:
a communication unit that preferentially wirelessly communicates with a portable media output device identified according to initially recorded device identification information;
a registration unit that stores in a user information storage unit user identification information of a user acquired from a user identification unit that identifies the user riding in a vehicle and the device identification information acquired by the communication unit in association with each other;
a device identification unit that reads from the user information storage unit the device identification information associated with the user identification information of the user riding in the vehicle acquired by the user identification unit when the user rides in the vehicle; and
an identification information notification unit that notifies the communication unit of the device identification information read by the device identification unit, wherein
the communication unit communicates with the portable media output device of the notified device identification information even if the notified device identification information is not initially recorded.

2. A vehicular audio/visual device comprising:
a communication unit that preferentially wirelessly communicates with a portable media output device identified according to initially recorded device identification information;
a user information storage unit that stores the device identification information of the portable media output device in association with user identification information of a user riding in a vehicle;
a device identification unit that reads from the user information storage unit the device identification information associated with the user identification information acquired from a user identification unit that identifies the user riding in the vehicle; and
an identification information notification unit that notifies the communication unit of the device identification information read by the device identification unit, wherein
the communication unit wirelessly communicates with the portable media output device of the notified device identification information even if the notified device identification information is not initially recorded.

3. A vehicular audio/visual system in which a vehicular audio/visual device outputs audio/visual data received from a portable media output device, wherein
the vehicular audio/visual device comprises:
a communication unit that preferentially wirelessly communicates with the portable media output device identified according to initially recorded device identification information;
a registration unit that stores in a user information storage unit user identification information of a user acquired from a user identification unit that identifies the user riding in a vehicle and the device identification information acquired by the communication unit in association with each other;
a device identification unit that reads from the user information storage unit the device identification information associated with the user identification information of the user riding in the vehicle acquired by the user identification unit when the user rides in the vehicle; and
an identification information notification unit that notifies the communication unit of the device identification information read by the device identification unit,
the communication unit wirelessly communicates with the portable media output device of the notified device identification information even if the notified device identification information is not initially recorded, and
the portable media output device comprises:
a communication unit that wirelessly communicates with the vehicular audio visual device; and
a reproduction unit that reproduces the audio/visual data.

4. A device identification method of a vehicular audio/visual device that preferentially wirelessly communicates with a portable media output device identified according to initially recorded device identification information using a communication unit, the method comprising:
a storage step in which a registration unit stores in a user information storage unit user identification information of a user acquired from a user identification unit that identifies the user riding in a vehicle and the device identification information acquired by the communication unit in association with each other;
a reading step in which a device identification unit reads from the user information storage unit the device identification information associated with the user identification information of the user riding in the vehicle acquired by the user identification unit when the user rides in the vehicle;
a notification step in which an identification information notification unit notifies the communication unit of the device identification information read by the device identification unit; and
a communication step in which the communication unit wirelessly communicates with the portable media output device of the notified device identification information even if the notified device identification information is not initially recorded.

5. A program causing a computer, which is connected to a communication unit that preferentially wirelessly communicates with a portable media output device identified according to initially recorded device identification information, to perform:
a storage step in which a registration unit stores in a user information storage unit user identification information of a user acquired from a user identification unit that identifies the user riding in a vehicle and the device identification information acquired by the communication unit in association with each other;
a reading step in which a device identification unit reads from the user information storage unit the device identification information associated with the user identification information of the user riding in the vehicle acquired by the user identification unit when the user rides in the vehicle;
a notification step in which an identification information notification unit notifies the communication unit of the device identification information read by the device identification unit; and
a communication step in which the communication unit wirelessly communicates with the portable media output device of the notified device identification information even if the notified device identification information is not initially recorded.

6. A computer-readable storage medium having stored therein the program according to claim 5.
